(19) United States
(12) Patent Application Publication
(10) Pub. No.: US 2007/0056518 A1
(43) Pub. Date: Mar. 15, 2007

(54) Natamycin for reduction in poultry condemnations

(76) Inventor: A. Franklin Carter, Laramy, WY (US)

Correspondence Address: MCCARTER & ENGLISH, LLP;BASIL S. KRIKELIS, CITIZENS BANK CENTER, 919 N. MARKET STREET, SUITE 1800, WILMINGTON, DE, 19801, US

(21) Appl. No.: 11/520,416

(22) Filed: Sep. 13, 2006

Related U.S. Application Data
(60) Provisional application No. 60/717,010, filed on Sep. 14, 2005.

(51) Int. Cl. A01K 39/00

(52) U.S. Cl. 119/51.01

(57) ABSTRACT

The present invention relates to a method for reducing the percentage of birds condemned in a poultry house by mixing an effective amount of natamycin into the feed of poultry and administering the feed to the poultry.

### CROSS REFERENCE TO RELATED APPLICATIONS

This application claims the benefit of U.S. Provisional Application No. 60/717,010, filed Sep. 14, 2005, the contents of which are incorporated herein by reference.

### FIELD OF THE INVENTION

The present invention relates to the use of natamycin to reduce condemnations in a poultry house. More specifically, the present invention relates to a method for reducing the percentage of birds condemned in a commercial poultry facility by mixing an effective amount of natamycin into the feed of poultry and administering the feed.

### BACKGROUND OF THE INVENTION

The poultry industry is growing to the point that poultry meat production and consumption has surpassed all other meats. Intensive production is a key feature in efficient productivity in the poultry industry. A consequence, however, of such intensive production is the increased risk of disease in the poultry. Loss of poultry is manifested in a variety of ways, including mortality, morbidity, condemnations, lower productivity and decreased efficiency of production.

Condemnation reports provide the statistics behind how many birds have been condemned to some problem that makes them unfit for their ultimate process. These reports are important to the poultry producer in that, from a very basic standpoint, they provide a quick summary of how well a flock has performed and are indicator of problems that arose. In fact, condemnation reports may provide the first realization to a producer that a problem existed in a flock. A poor condemnation report is not well viewed as the condemned birds are discarded at the end of the production cycle. As such, the end result is that the condemned birds have been responsible for production costs, feed, heating costs and various other costs associated with production while providing no return.

Condemnations are the cause of approximately 3%-5% of bird losses in a flock. The majority of condemnations are due to infections in the respiratory tract. Respiratory diseases can be the result of any one of or a combination of factors, including the genetic make up of the bird itself, pathogenic infections and the environment in general. The genetic make up of the host may be a major contributor to an increased susceptibility or resistance to disease. Secondly, in the majority of respiratory diseases, primary and secondary infections are involved in the disease process. Causative agents of respiratory diseases are difficult to control as they are constantly undergoing mutations, while new agents are always emerging or re-emerging. Finally, the environment of the poultry house (i.e. temperature, humidity, dust, gases, etc.) may be just as influential. Other causes of condemnations as reported by the USDA include leucosis, septicemia, airsaculitis, synovitis, tumors, bruises, cadaver, contamination and overscald, among others (USDA Poultry Slaughter 2005 Annual Summary, United States Department of Agriculture, Pou 2-1 (06), February 2006).

While producers attempt to keep condemnations as low as possible by providing better living environments, vaccinations and growing healthier flocks of chickens in general, in view of all of the factors involved, condemnations continue to occur at levels that are much too high.

Anti-mycotic materials are materials that inhibit mold, yeast, and fungal growth. One particular anti-mycotic is natamycin, one of the few anti-mycotics that has been approved as a food additive by the Food and Drug Agency of the U.S. government. Natamycin can be obtained commercially from, for example, Gist-Brocades Food Ingredients, Inc. (as Delvocide®) or Cultor Food Science (as Natanex®).

In view of the beneficial aspects of anti-mycotics, poultry feeds are often treated with various anti-mycotics, such as natamycin, to prevent or inhibit certain conditions. For example, U.S. Pat. No. 4,600,706 sets forth a method for treating animal feed with natamycin to reduce or prevent fungal or mold growth. Similarly, natamycin has been incorporated into animal feed to improve animal feed efficiency (U.S. Pat. No. 4,536,494) and to reduce the incidence of the disease ascites (U.S. Pat. No. 5,985,845).

The prior art does not disclose, however, whether anti-mycotics such as natamycin, or any other mold inhibitors, have an effect reducing condemnations in avians.

### SUMMARY OF THE INVENTION

The primary object of this invention is to provide a method for reducing the number of condemned birds in a flock of poultry, the method comprising a) starting a flock of poultry; b) administering an effective amount of natamycin to said flock; c) raising said flock to market weight; and d) reducing the number of condemned birds in said market weight flock of poultry to a number less than the number of condemned birds in a market weight flock of poultry not administered natamycin.

An additional object of the invention is a method for reducing the number of condemned birds in a flock of poultry, the method comprising a) starting a flock of poultry; b) adding an effective amount of natamycin to the feed of said flock; c) raising said flock to market weight; and d) reducing the number of condemned birds in said market weight flock of poultry to a number less than the number of condemned birds in a market weight flock of poultry not administered natamycin.

### DETAILED DESCRIPTION OF THE INVENTION

The present invention is directed to the novel finding that the administration of natamycin to avians is surprisingly effective in reducing the percentage or number of birds that are condemned in a commercial avian production facility. More particularly, the invention is directed to the reduction in the number of avians that, once raised to market weight, need to be condemned at the time of slaughter due to various deficiencies. This reduction in condemned market weight birds results from the administration to the birds of an effective amount of natamycin. It is preferred that the natamycin be added to the feed of the avians, and, as such, the natamycin is ingested while feeding.

In most case of avian production (aside from poultry used for egg production), the birds are grown to a market weight at which point they are slaughtered and their meat is sold. Market weight for meat-type broilers, for example, is in the range of 3-7 lbs depending upon the needs of the particular consumer. In fact, entire flocks of birds are grown to the particular market weight for said flock. Administration of the natamycin is preferably accomplished during the growth of the birds/flocks up to the point of achieving the desired market weight.

The markedly significant reduction in the number of condemned birds is a surprising and unusual result for a known mold inhibitor such as natamycin. The administration of other known mold inhibitors, such as propionionic acid, derivatives thereof and other acidulants that help lower the pH and slow growth of mold, does not result in a reduction of condemned birds, let alone such a significant reduction as seen by the administration of natamycin. While not bound by any particular theory, applicants suggest that one possibility may be that these other known mold inhibitors don't kill molds as effectively as natamycin, or do not destroy as broad a spectrum of molds of different species, and, as such, perhaps more molds survive and end up affecting the birds negatively. An alternative, and more striking theory is that other mold inhibitors, and in particular, acidulants, are deactivated in the upper GI tract of the birds, and as such, do not remain biologically active past that point. Molds, however, can grow in the intestine and lower intestine where such known mold inhibitors are not active. Natamycin, on the other hand, remains biologically active through the entire GI tract, and, as such, can destroy molds within the intestine.

The term “avian” is used in this document to refer to any animal that is a member of the class Aves. Within the class Aves, domesticated fowl or poultry are preferred, and is inclusive of other members of this class such as turkeys, ducks, and geese, among others. Natamycin

Natamycin is an anti-mycotic that may also be referred to by the other names of primarcin or tennectin. In its natural form, it is a creamy white, odorless, tasteless, practically insoluble crystalline amphoteric powder. It belongs to the polyene macrolide or macrocyclic lactone group of compounds. It is relatively stable when in a dry state or when mixed with dry diluents. The molecule, however, is sensitive to ultraviolet light, oxygen, or extreme pH values. It is relatively insoluble in water in which its solubility is of the order 0.005-0.010 weight/weight percent. Additionally, even in solutions, natamycin is rather unstable. Aqueous solutions of 6 mcg/ml of natamycin become microbiologically inactive after twenty-four hour exposure to light. Inactivation of natamycin by light, peroxides or oxygen proceeds at the fastest rate in solution or suspension. Natamycin is also sensitive to heavy metals, and may lose up to 75% of its effectiveness in four to five hours in their presence.

Natamycin has been applied to food products for a variety of uses, most notably, to reduce mold growth. It can be applied to the food products in several ways. It can be added in dry form to liquids, slurries, pastes and semisolids when adequate mixing can be accomplished, or the pure natamycin can be mixed with one or more of the dry ingredients and then added to a given food product. Solid foods requiring surface protection can be dipped, misted, fogged or dusted with a solution or suspension of natamycin. Additionally, natamycin may be incorporated homogeneously into the food itself.

Animal Feed

Animal feed is largely composed of grain and cereal products, but may also include meat byproducts as a minor ingredient. Additionally, animal feed may include citrus pulp and grape hulls, either or both being present at less than about 5% by weight. Animal feed can also include added fats, vitamins and minerals, including riboflavin and trace metals.

Animal feed for feeding poultry includes protein, fat, fiber, calcium and phosphorous. A preferred feed would include corn and/or wheat, fat, meat meal, soybean meal, vitamins and minerals.

Animal feed is generally formed by cracking or grinding grain, rather than by incorporating the intact grain particles. These ground or cracked particles in the feed are roughly 1/100 of the original grain size. Animal feeds are composed of many different particles, typically in a range between 1/32 of an inch, or less, to ⅛ of an inch in diameter. Additionally, the cracking process exposes higher moisture and different nutrient concentrations than are typically present at the surface of the grain particle, which usually has a hull or other coating. Thus, the increased moisture content of conventional feeds may decrease the stability of natamycin according to the literature in this art.

Feed is also generally exposed to light during its manufacture. It is thereafter typically stored in dark bins with lids to keep out moisture. The moisture content of the feed, however, ranges from 10-30%. Additionally, in use, uneaten leftover feed is thoroughly exposed to light, as it is retained in the pans that are typically found in automated feed systems. Thus, some feed may be retained for a week or more before it is consumed in an environment of high moisture and with exposure to ultraviolet and visible light rays, again potentially decreasing the stability of natamycin added thereto.

Natamycin Administration

The beneficial effects of the invention are observed when the avians are administered natamycin at some point in, or even throughout their life cycle prior to slaughter. While natamycin can be administered by any method know in the art, it is preferred that the natamycin be administered by being added to avian feed. This method provides a controllable administration method that is easily applicable to avians. It is preferred that the natamycin been added to feed throughout the life cycle of the birds, and, in particular, that it be formulated into starter, grower and finisher feeds, although, in certain cases, it may only be necessary to add the natamycin to less than all of the growth phase feed formulations.

When used in poultry feed, it is preferred that the natamycin is initially mixed into a premix. The term “premix” is intended to mean a feed composition that is prepared as an initial mix containing the active ingredient and, for example, a carrier, and is then blended into the final feed. In the present invention, it is generally suggested, for ease of calculation, that one pound of the premix is blended with about one ton of conventional feed, with the result that the necessary dosage requirements of the natamycin are provided to the poultry to provide the desired result of decreased condemnations. The premix of the invention preferably comprises about 2 to 25, and more preferably, about 5 to 20, grams of natamycin per pound of a carrier and most preferably about 10 grams of natamycin per pound of carrier. While the preferred carrier for use in the invention is calcium carbonate, virtually any other carrier can be used for purposes of forming a premix. Carriers for use in a premix, are well known by those having skill in the art, and appropriate concentrations can be readily determined. Some examples include rice hulls, walnut shells, zeolite, bentonite, and silica dioxides, to name a few.

The natamycin may be added to the carrier as a dry powder or as a liquid solution or suspension. When added as a liquid, the natamycin may be dissolved or suspended in a liquid with stirring at room temperature in about five minutes by adding about 2 to 25 grams of, for example, natamycin crystals to an appropriate solution, such as propylene glycol or methanol, or any other solvent in which natamycin will dissolve or be suspended. Because of natamycin's limited solubility, it usually will not completely go into solution, but may form a suspension. An optional volume for suspending 2 to 25 grams of natamycin is approximately 30 to 60 mL of an appropriate solution. Preferably, such an amount of natamycin is then added to about one pound of a conventional premix, and will not overly wet it. Once the premix is prepared, the premix is then added to the final feed, preferably at a rate in the range of one-half pound to 10 pounds of premix to one ton of feed, and most preferably, one pound of premix per one ton of feed, to supply daily requirements of the natamycin for the poultry.

A preferred premix composition includes rice hulls because they are beneficial due to their relatively low price. Other premix materials, however, may be used, including minerals such as calcium carbonate (limestone), inert products such as soybean mill feed and corn cob fractions, and any other related premix materials. Those having skill in the art are familiar with products that function or serve effectively in premix mixes, and, as such, can determine which premix material best serves their purposes. Although not required, generally it is preferred that the premix materials comprise an inert substance or substances.

The natamycin solid or suspension can be added directly to the premix material, and then mixed. Mixing can be accomplished by any known means, such as by a standard horizontal or vertical blender. Mixing time will again vary depending upon the particular ingredients of the premix, and can take as long as is necessary to assure that the ingredients are thoroughly mixed. In the preferred embodiment, mixing of the premix takes approximately 5-20 minutes.

The premix is then incorporated into the feed to be fed to the poultry. In a more preferred embodiment, natamycin, in a dry powder form, is blended with the preferred carrier calcium carbonate to form the premix, and the premix is directly blended into the final feed.

While it is preferred that the natamycin be mixed with a premix material prior to incorporation into the finished feed, the appropriate amount of natamycin can alternatively be blended directly into the feed. The preferred additive range of natamycin in finished feed, whether added directly or via a premix, is about 0.000011 to 0.011 weight percent (about 0.1 to 100 grams per ton of feed); more preferably about 0.000055 to 0.0055 weight percent (about 0.5 to 50 grams per ton); even more preferably about 0.00022 to 0.0028 weight percent (about 2 to 25 grams per ton), and most preferably 0.00088 to 0.0017 weight percent (about 8 to 15 grams per ton). In a preferred embodiment, this amount of natamycin is prepared, as discussed above, and added to about one pound of premix carrier. While there is no evidence that use of the higher amounts would cause any toxicity problems in treated poultry, it will affect cost considerations. Because the premix generally will be added to one-ton charges of feed (as is common in the industry), the correspondence between one gram of natamycin added to the premix yields about 1 ppm concentration of natamycin in the feed (about 0.0001 weight percent). Thus, 10 grams of natamycin added to one pound of premix, which in turn is added to one ton of feed, yields about an 11 ppm effective natamycin concentration.

Feed is conventionally prepared in a large bin or mixer in which the feed ingredients are added in descending weight order according to their prevalence in the ultimate feed mixture. Thus, cracked grain would be the primary ingredient. Minor ingredients are then added. Micro-ingredients are added last. These include vitamins, drugs, growth promoters, antibiotics, and, in the present case, natamycin. Thus, natamycin can be one of the micro-ingredients and is added to the feed in the final blending step. The feed is blended for conventional time periods.

The feed comprising the natamycin is fed to the flock at standard feed dosage ranges and rates. Based in the above amounts of natamycin contained in the feed, the dosage amount for each chicken or turkey per day would preferably be about 0.0008 grams to about 0.033 grams, and more preferably, about 0.0016 grams to about 0.0083 grams.

The advantageous properties of this invention can be observed by reference to the following examples that illustrate the invention. These examples are provided for the purposes of illustration and are not intended to limit the scope of the present invention.

### EXAMPLES

### Example 1

Measurement of Condemnations in Commercial Production Facilities

Testing Facilities:

Testing was conducted at established poultry production facilities in Hurlock, Md. and Arcadia, La.

Test System:

| | |
|---|---|
| Species: | Chickens |
| Strain: | Commercial Broilers |
| Age: | To: 42-49 days |
| Sex: | Mixed |
| Total No. of Birds: | 1.75 Million |

Feeds:

a) Feed was commercial starter, grower and finisher/withdrawal diets.

b) Starter was fed as crumbles from approximately 0-21 days. The remaining diets were fed as pellets until the birds were slaughtered at 42-49 days.

c) The feeds were manufactured by commercial feed mills at the poultry production complexes in each geographic location and then blinded.

Natamycin:

The natamycin was administered via the feed in order to approximate, as closely as possible, the conditions under which the natamycin will be administered in the commercial setting.

Methods:

The field trials were conducted at commercial poultry production complexes in two diverse geographic locations. In each study, 1000 broilers were used. The broiler chicken feed was produced at a commercial feed mill. Starter, Grower and Finisher/Withdrawal diets were formulated to include one pound of either a treatment premix (containing 10 grams of natamycin per pound) or a control (blank) premix in each ton of finished feed. The resulting treatment feed thus contained 10 grams of natamycin per ton (11 ppm), and the control feed contained no natamycin.

In the mixing studies, 4 batches of contol and 4 batches of treatment feed were prepared. Treatment batches were randomly assigned. Batch sizes were typical batch sizes for each facility. The test feeds were fed continuously to the broilers until slaughter. Those broilers that were started on treatment feed received treatment feed until slaughter. Those fed control feed were fed control feed throughout as well. Samples of feed were obtained periodically (on or about days 0, 15, 30 and 45) for analysis of natamycin content by high pressure liquid chromatography (HPLC). Records were kept to measure a variety of data, including, among other things, average weight, feed conversion, mortality, and condemnations.

Results:

Results of the study are presented in Tables 1 and 2 below. Table 1 provides the data from the Arcadia, La. facility which showed a decrease in condemnations from 0.86% in the untreated group to 0.78% in the natamycin treated group. Table 2 provides the results of the study run at the Hurlock, Md. facility where the condemnations were reduced from 0.39% in the untreated group to 0.23% in the natamycin treated group. The reductions in condemnations observed in both of these studies are considered significant in the commercial poultry production industry.

TABLE 1

| | Control | Treated |
|---|---|---|
| Number of Birds | 1000 | 1000 |
| Mortality | 5.98% | 5.15% |
| Weight (lbs.) | 3.89 | 4.09 |
| Feed Conversion | 1.79 | 1.78 |
| % Condemned | 0.86% | 0.78% |

TABLE 2

| | CONTROL | TREATED |
|---|---|---|
| Number of Birds | 1000 | 1000 |
| Mortality | 1.73% | 0.88% |
| Weight (lbs.) | 5.06 | 5.12 |
| Feed Conversion | 2.07 | 2.04 |
| % Condemned | 0.39% | 0.23% |

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A method for reducing the number of condemned birds in a flock of poultry, the method comprising:
a. starting a flock of poultry;
b. administering an effective amount of natamycin to said flock;
c. raising said flock to market weight; and
d. reducing the number of condemned birds in said market weight flock of poultry to a number less than the number of condemned birds in a market weight flock of poultry not administered natamycin.

2. The method of claim 1 wherein said natamycin is added to poultry feed.

3. The method of claim 2 wherein said poultry feed comprises about 0.000011 to about 0.011 weight percent natamycin.

4. The method of claim 2 wherein said natamycin is formulated in a premix comprising natamycin and a carrier.

5. The method of claim 4 wherein said premix comprises about 2 to about 25 grams of natamycin per pound of carrier.

6. The method of claim 5 wherein said carrier is selected from the group consisting of rice hulls, walnut shells, zeolite, bentonite, silica dioxides and combinations thereof.

7. The method of claim 2 wherein said natamycin is formulated into a diet selected from the group consisting of starter, grower and finisher.

8. The method of claim 1 wherein each bird is administered about 0.0008 grams to about 0.033 grams of natamycin.

9. The method of claim 1 wherein said flock of poultry is raised in a commercial poultry facility.

10. A method for reducing the number of condemned birds in a flock of poultry, the method comprising:
a. starting a flock of poultry;
b. adding an effective amount of natamycin to the feed of said flock;
c. raising said flock to market weight; and
d. reducing the number of condemned birds in said market weight flock of poultry to a number less than the number of condemned birds in a market weight flock of poultry not administered natamycin.

11. The method of claim 10 wherein said feed comprises about 0.000011 to about 0.011 weight percent natamycin.

12. The method of claim 10 wherein said natamycin is formulated in a premix comprising natamycin and a carrier.

13. The method of claim 12 wherein said premix comprises about 2 to about 25 grams of natamycin per pound of carrier.

14. The method of claim 13 wherein said carrier is selected from the group consisting of rice hulls, walnut shells, zeolite, bentonite, silica dioxides and combinations thereof.

15. The method of claim 10 wherein said natamycin is formulated into a diet selected from the group consisting of starter, grower and finisher.

16. The method of claim 10 wherein each bird is administered about 0.0008 grams to about 0.033 grams of natamycin.

17. The method of claim 10 wherein said flock of poultry is raised in a commercial poultry facility.
